(19) United States
(12) Patent Application Publication
(10) Pub. No.: US 2009/0073446 A1
(43) Pub. Date: Mar. 19, 2009

(54) Lighting Subsystem for a Machine Vision System

(75) Inventors: Douglas Davidson, Saline, MI (US); Jon Upham, Saline, MI (US)

Correspondence Address: SCHOX PLC, 730 Florida Street #2, San Francisco, CA, 94110, US

(73) Assignee: COHERIX, INC., Ann Arbor, MI (US)

(21) Appl. No.: 11/916,653

(22) PCT Filed: Jun. 13, 2006
(86) PCT No.: PCT/US2006/023030

§ 371 Date: Sep. 23, 2008

Related U.S. Application Data
(60) Provisional application No. 60/689,966, filed on Jun. 13, 2005.

(51) Int. Cl. G01N 21/55

(52) U.S. Cl. 356/445

(57) ABSTRACT

According to one of the preferred embodiments, the invention includes a machine vision system 110 for inspecting a moving object. The machine vision system 110 includes a camera subsystem 30 to capture the image of a moving object when the object moves into a viewing area, a lighting subsystem 12 to illuminate the moving object, and a controller 14 to control the camera subsystem and the lighting subsystem to effectively freeze and inspect the reflectance of the illumination by the moving object. The lighting subsystem includes light sources 16 arranged around the viewing area.

### CROSS-REFERENCE TO RELATED APPLICATIONS

This application claims the benefit of U.S. Provisional Application No. 60/689,966 filed 13 Jun. 2005, which is incorporated in its entirety by this reference.

### TECHNICAL FIELD

This invention relates generally to the machine vision field, and more specifically to new and useful lighting subsystem in the machine vision field.

### BRIEF DESCRIPTION OF THE FIGURES

FIG. 1 is a perspective view, looking upward, of the system of the first preferred embodiment.

FIG. 2 is a perspective view, looking upward, of the lighting subsystem of the first preferred embodiment.

FIG. 3 is a schematic representation of the controller of the first preferred embodiment.

FIGS. 4 and 5 are perspective views, both looking downward, of the system of the second preferred embodiment.

FIG. 6 is a perspective view, looking upward, of the system of the third preferred embodiment.

FIG. 7 is a perspective view, looking upward, of the second lighting subsystem of the third preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

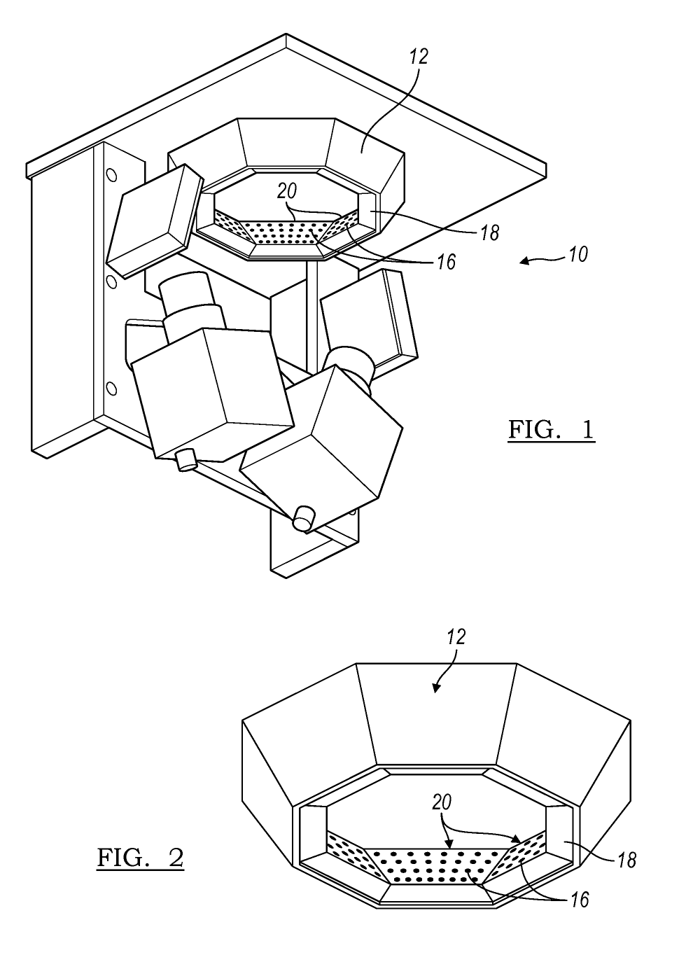

As shown in FIGS. 1-3, the system 10 of the first preferred embodiment includes a lighting subsystem 12 to illuminate a moving object and a controller 14 to selectively activate the lighting subsystem 12 to allow observation of the reflectance of complex objects under different conditions. The system 10 has been specifically designed for illuminating a moving object, such as the connecting terminals (e.g., leads, ball grids, and pads) of packaged electronic components in a manufacturing facility. The system 10 may, however, be used to illuminate any suitable moving or non-moving object.

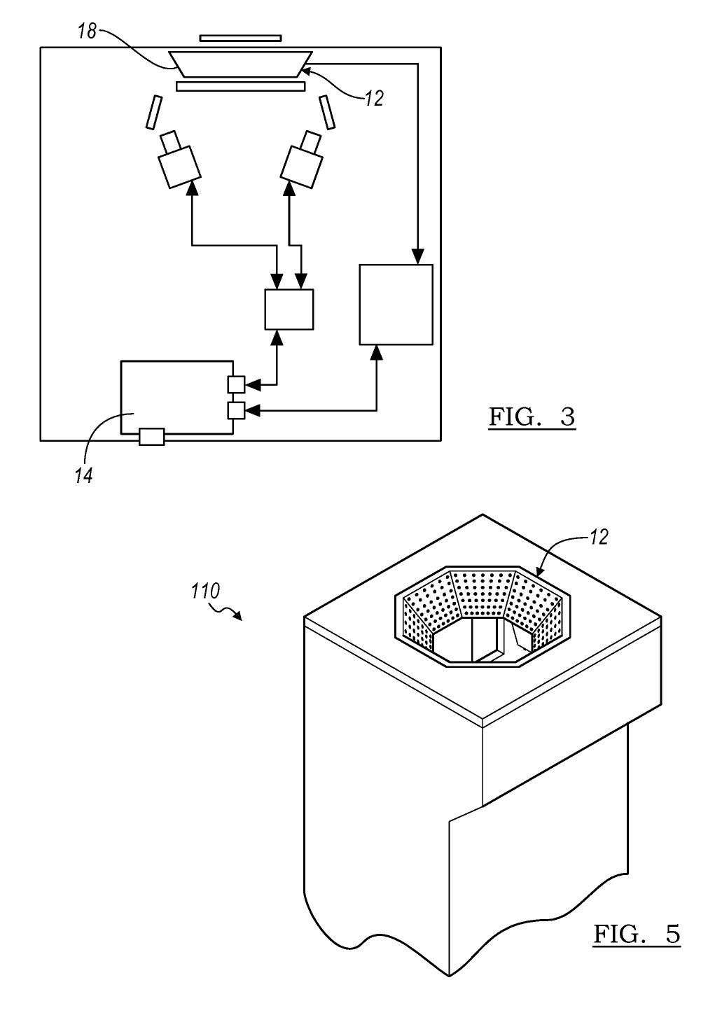

As shown in FIG. 2, the lighting subsystem 12 of the first preferred embodiment functions to illuminate a moving object, when the object is within a viewing area. The lighting subsystem 12 preferably includes light sources 16 arranged in a symmetrical pattern around the viewing area. The light sources 16 are preferably arranged in a circular pattern. To reduce manufacturing complexity and costs, the light sources 16 may be alternatively mounted on a primary structural member 18 with a polygonal shape that approximates a circular pattern. The primary structural member 18 preferably includes six or eight sides, but may have any suitable number of sides that approximates a circular pattern. The light sources 16 may, alternatively, be mounted on any suitable structural member. The lighting subsystem 12 preferably includes light banks 20, which each consist of a group of light sources 16 that are arranged in a plane and are aimed toward the viewing area with a substantially similar illumination angle. The lighting subsystem 12 preferably includes three or four light banks 20, but may alternatively include any suitable number of light banks 20.

The light sources 16 of the lighting subsystem 12 of the first preferred embodiment function to provide a high-intensity illumination of the moving object. The lighting subsystem 12 preferably includes at least 48 high-intensity LEDs, which are preferably arranged in a six-sided pattern with two light banks (4 LEDs/bank/side, with 6 sides, and with 2 light banks). More preferably, the lighting subsystem 12 includes at least 108 high-intensity LEDs, which are preferably arranged in a six-sided pattern with three light banks (6 LEDs/bank/side, with 6 sides, and with 3 light banks). Most preferably, the lighting subsystem 12 includes at least 192 high-intensity LEDs, which are preferably arranged in an eight-sided pattern with four light banks (6 LEDs/bank/side, with 8 sides, and with 4 light banks).

As shown in FIG. 3, the controller 14 of the first preferred embodiment, which is connected to the lighting subsystem 12, functions to control the lighting subsystem 12 to allow observation of the reflectance of the illumination by the moving object under different conditions. In one variation, the controller 14 controls the activation of the lighting subsystem 12. Based on the information collected by a machine vision subsystem, the controller 14 may adjust the activation of the light sources 16 of the lighting subsystem 12 to strobe at a faster or slower cycle (e.g., 50 ms), at an earlier or later time within the cycle (+1 ms), for a longer or shorter duration (e.g., 5-50 microseconds), and/or at a higher or lower intensity (e.g., 0-50 amps). The controller 14 may, however, adjust any suitable parameter of the lighting subsystem 12 to allow observation of the reflectance of the illumination by the moving object under different conditions.

In another variation, the controller 14 controls the activation of particular groups of the lighting subsystem 12. Based on the information collected by a machine vision subsystem, the controller 14 may adjust the activation of the light sources 16 of one or more light banks 20 of the lighting subsystem 12 to strobe at a faster or slower cycle (e.g., 50 ms), at an earlier or later time within the cycle (+1 ms), for a longer or shorter duration (e.g., 5-50 microseconds), and/or at a higher or lower intensity (e.g., 0-50 amps) than other light banks 20 of the lighting subsystem 12. By controlling light banks 20 in this manner, the lighting subsystem 12 preferably generates different light illumination angles, while ensuring a substantial degree of illumination symmetry. The controller 14 may, however, adjust any suitable parameter of the light banks 20 of the lighting subsystem 12 to allow observation of the reflectance of the illumination by the moving object under different conditions.

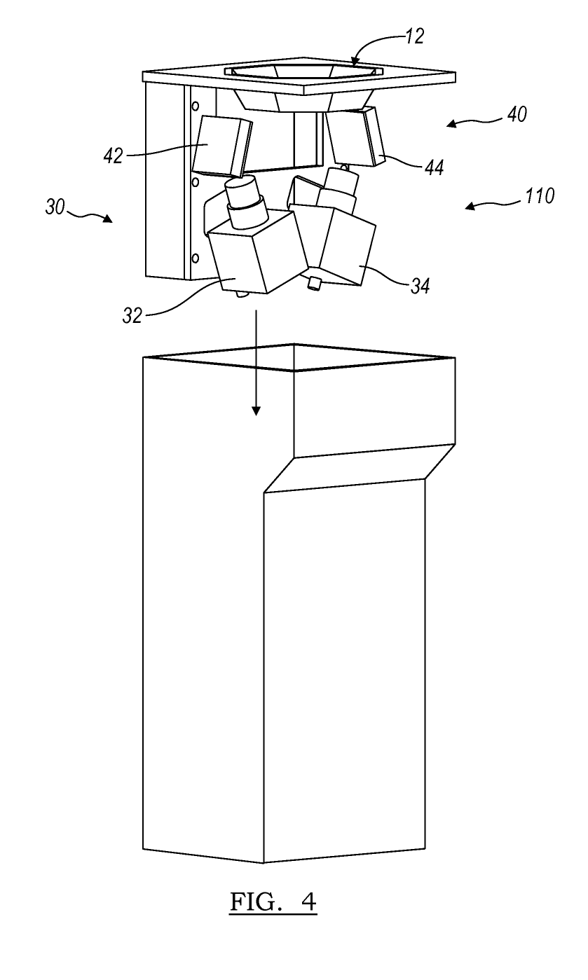

As shown in FIGS. 4 and 5, the system 110 of the second preferred embodiment includes a lighting subsystem 12 to illuminate a moving object, a controller to selectively activate the lighting subsystem 12 to allow observation of the reflectance of complex objects under different conditions, and a camera subsystem 30 to capture the image of a moving object when the object moves into a viewing area. The system 110 has been specifically designed for illuminating and capturing the image of a moving object, such as the connecting terminals (e.g., leads, ball grids, and pads) of packaged electronic components in a manufacturing facility. The system 110 may, however, be used to illuminate and capture the image of any suitable moving or non-moving object.

The camera subsystem 30 of the second preferred embodiment functions to capture the image of a moving object when the object moves into a viewing area. Preferably, the camera subsystem 30 includes a first camera 32 and a second camera 34 to provide information on the moving object from several angles. More preferably, the camera subsystem 30 also includes a third camera. The camera subsystem 30 may, however, include any suitable number of cameras to provide information on the moving object from several angles. Each camera is preferably a CCD-type camera with a resolution of at least 2 MB at 12-bit grayscale and a field of view of at least 50 mm by 50 mm. Each camera may, however, be any suitable type of image capturing device with any suitable resolution and any suitable field of view. Each camera preferably has a unique viewing angle of the viewing area. The first camera 32 and the second camera 34 preferably have acute and obtuse viewing angles that are complimentary (e.g., 60° and 120° ), while the third camera preferably has a perpendicular viewing angle (i.e., 90°).

The controller of the second preferred embodiment, which is connected to the camera subsystem 30 and to the lighting subsystem 12, functions to control the camera subsystem 30 and the lighting subsystem 12 to allow observation of the reflectance of the illumination by the moving object under different conditions. Through the manipulation of the activation of the camera subsystem 30 and the lighting subsystem 12, the system 110 of the second preferred embodiment may effectively freeze and inspect the reflectance of the illumination by the moving object. In all other aspects, the controller of the second preferred embodiment is preferably identical to the controller 14 of the first preferred embodiment.

As an optional variation, the system 110 of the second preferred embodiment may also include a mirror assembly 40. The mirror assembly 40 functions to allow compactness of the system 110 and to facilitate particular viewing angles of the first camera 32 and the second camera 34. Preferably, the mirror assembly 40 includes a first mirror 42 that optically folds the view of the first camera 32, and a second mirror 44 that optically folds the view of the second camera 34.

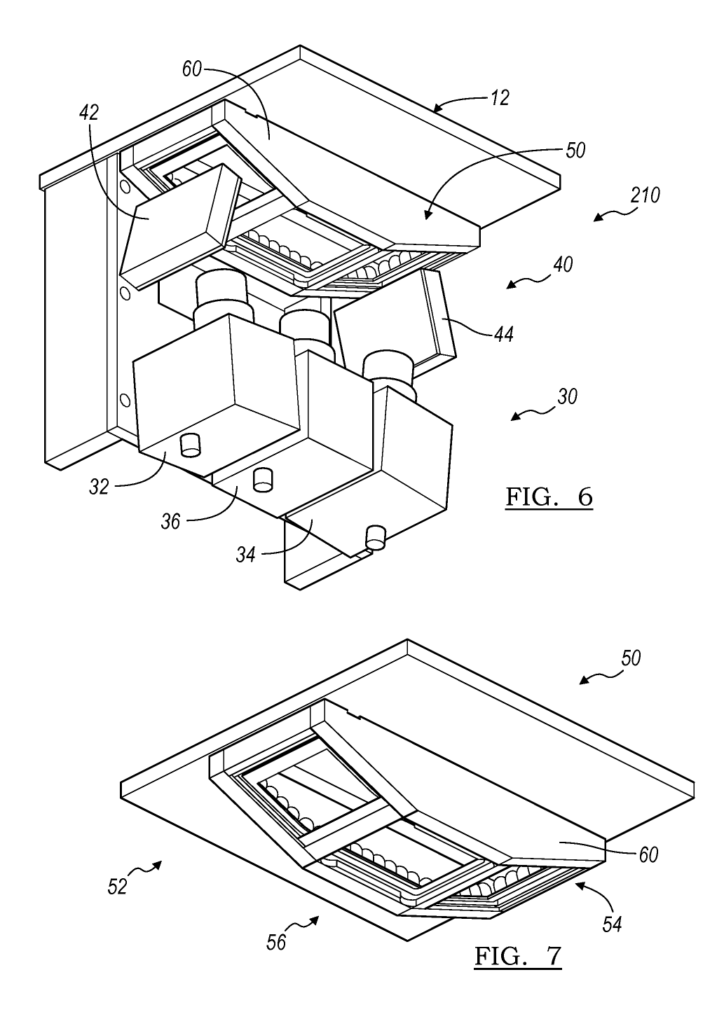

As shown in FIGS. 6 and 7, the system 210 of the third preferred embodiment includes a primary lighting subsystem 12 and a secondary lighting subsystem 50 to illuminate a moving object, a controller to selectively activate the primary lighting subsystem 12 and the secondary lighting subsystem 50 to allow observation of the reflectance of complex objects under different conditions, and a camera subsystem 30 to capture the image of a moving object when the object moves into a viewing area. The system 210 has been specifically designed for illuminating and capturing the image of a moving object, such as the connecting terminals (e.g., leads, ball grids, and pads) of packaged electronic components in a manufacturing facility. The system 210 may, however, be used to illuminate and capture the image of any suitable moving or non-moving object.

The primary lighting subsystem 12 and the camera subsystem 30 of the third preferred embodiment are preferably identical to the lighting subsystem and the camera subsystem of the second preferred embodiments.

The secondary lighting subsystem 50 of the third preferred embodiment functions to illuminate the moving object. The secondary lighting subsystem 50 preferably includes a first light group 52 with light sources 16 aimed toward the viewing area along the viewing angle of the first camera 32, a second light group 54 with light sources 16 aimed toward the viewing area along the viewing angle of the second camera 34, and a third light group 56 with light sources 16 aimed toward the viewing area along the viewing angle of a third camera 36. Preferably, the secondary lighting subsystem 50 is mounted on a secondary structural member 60 with a trapezoidal shaper and the camera subsystem 30 and secondary structural member 60 are arranged such that the cameras point through holes in the secondary structural member 60. The secondary lighting subsystem 50 may, however, be mounted on any suitable structural member. The secondary lighting subsystem 50 preferably includes at least 8 high-intensity LEDs in each of the light groups, but may alternatively include any suitable number of suitable light sources 16.

The controller of the third preferred embodiment functions, like the controller of the second preferred embodiment, functions to control the camera subsystem 30 and the lighting subsystem 12 to allow observation of the reflectance of the illumination by the moving object under different conditions. The controller of the third preferred embodiment, however, is further connected to the secondary lighting subsystem 50 and is further adapted to selectively activate and/or adjust the intensity of the primary lighting subsystem 12 and/or the secondary lighting subsystem 50 to produce different incident light illumination angles, while ensuring a substantial degree of illumination symmetry. Through the manipulation of the activation of the camera subsystem 30, the primary lighting subsystem 12, and the secondary lighting subsystem 50, the system 210 of the third preferred embodiment may effectively freeze and inspect the reflectance of the illumination by the moving object. In all other aspects, the controller of the third preferred embodiment is preferably identical to the controller of the second preferred embodiment.

As a person skilled in the art will recognize from the previous detailed description and from the figures and claims, modifications and changes can be made to the preferred embodiments of the invention without departing from the scope of this invention defined in the following claims.

I claim:

1. A machine vision system for inspecting a moving object, comprising:
a camera subsystem adapted to capture the image of a moving object when the object moves into a viewing area;
a primary lighting subsystem adapted to illuminate the moving object, wherein the primary lighting subsystem includes light sources arranged around the viewing area; and
a controller coupled to the camera subsystem and to the primary lighting subsystem and adapted to control the camera subsystem and the lighting subsystem to effectively freeze and inspect the reflectance of the illumination by the moving object.

2. The system of claim 1, wherein the light sources are arranged in a symmetrical pattern around the viewing area.

3. The system of claim 2, wherein the light sources are arranged in a polygonal pattern with at least six sides.

4. The system of claim 3, wherein the controller is further adapted to selectively adjust the intensity of the light sources.

5. The system of claim 4, wherein the primary lighting subsystem includes at least 48 high-intensity LEDs.

6. The system of claim 2, wherein the light sources are grouped in light banks, wherein the light sources of each light bank are arranged in a plane and are aimed toward the viewing area with a substantially similar illumination angle.

7. The system of claim 6, wherein the controller is further adapted to selectively activate one or more of the light banks.

8. The system of claim 7, wherein the controller is further adapted to selectively adjust the intensity of the light banks.

9. The system of claim 8, wherein the primary lighting subsystem includes at least 2 light banks, wherein each light bank includes at least 24 high-intensity LEDs.

10. The system of claim 2, wherein the camera subsystem includes at least three cameras, wherein the first camera is adapted to image the moving object at a first viewing angle, wherein the second camera is adapted to image the moving object at a second viewing angle, and wherein the third camera is adapted to image the moving object at a third viewing angle.

11. The system of claim 10, further comprising a first mirror for the first camera and a second mirror for the second camera.

12. The system of claim 10, further comprising a secondary lighting subsystem adapted to illuminate the moving object, wherein the secondary lighting subsystem includes light sources in a first light group aimed toward the viewing area along the first viewing angle, light sources in a second light group aimed toward the viewing area along the second viewing angle, and light sources in a third light group aimed toward the viewing area along the third viewing angle.

13. The system of claim 12, wherein the controller is further adapted to selectively activate one or more of the primary lighting subsystem and the secondary lighting subsystem.

14. The system of claim 13, wherein the controller is further adapted to selectively adjust the intensity of the light sources of the primary lighting subsystem and the light sources of the secondary lighting subsystem.

15. The system of claim 14, wherein the primary lighting subsystem includes at least 48 high-intensity LEDs, and wherein the secondary lighting subsystem includes at least 8 high-intensity LEDs in each of the light groups.

16. A lighting subsystem for a machine vision system comprising:
a lighting subsystem adapted to illuminate an object, wherein the primary lighting subsystem includes light sources arranged around the viewing area; and
a controller coupled to the camera subsystem and to the primary lighting subsystem and adapted to control the camera subsystem and the lighting subsystem to effectively freeze and inspect the reflectance of the illumination by the moving object.

17. The subsystem of claim 16, wherein the light sources are arranged in a symmetrical pattern around the viewing area.

18. The subsystem of claim 17, wherein the light sources are grouped in light banks, wherein the light sources of each light bank are arranged in a plane and are aimed toward the viewing area with a substantially similar illumination angle.

19. The subsystem of claim 18, wherein the controller is further adapted to selectively activate one or more of the light banks and to selectively adjust the intensity of the light banks.

20. The subsystem of claim 19, wherein the primary lighting subsystem includes at least 2 light banks, wherein each light bank includes at least 24 high-intensity LEDs.
